(19) United States
(12) Patent Application Publication
(10) Pub. No.: US 2008/0194382 A1
(43) Pub. Date: Aug. 14, 2008

(54) Motor Vehicle Driving Train and Process For Controlling an Automated Engine Clutch

(75) Inventors: Rainer Petzold, Friedrichshafen (DE); Mario Steinborn, Friedrichshafen (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 11/913,946

(22) PCT Filed: Apr. 18, 2006
(86) PCT No.: PCT/EP2006/003508

§ 371 Date: Nov. 9, 2007

(30) Foreign Application Priority Data
May 10, 2005 (DE) 102005021416.9

(51) Int. Cl. F16D 48/06

(52) U.S. Cl. 477/86

(57) ABSTRACT

A power train of a motor vehicle with a drive motor (2), a transmission (4) with variable transmission ratios connected to an axle drive (5), and an automatic motor clutch. The automatic motor clutch is a passively lockable friction clutch actuated by a spring-loaded pressing device (6) and whose transferable rotational toque (coupling torquet) is adjusted using a clutch actuator (7), and is located in the flow of power between the drive motor (2) and the transmission (4). Improved controllability and a more rapid response of the motor clutch (3) is achieved by the spring-supported pressing device (6) to produce a basic coupling torque below the maximum rotational torque of the drive motor (2) and, a second pressing device (17) regulates a higher coupling torque by way of an effective connection with the clutch actuator (7).

The invention involves a power train of a motor vehicle with a drive motor (2) constructed as a combustion engine, a transmission (4) with variable transmission ratios connected to an axle drive (5), and with an automatic motor clutch, which is constructed as a passively lockable friction clutch by means of a spring-loaded pressing device (6) and whose transferable rotational moment (coupling moment) is adjusted using a clutch actuator (7), located in the power flow between the drive motor (2) and the transmission (4). To achieve an improved controllability and a more rapid response of the motor clutch (3) the spring-supported pressing device (6) is designed to produce a basic coupling moment lying below the maximum rotational moment of the drive motor (2) and to regulate a higher coupling moment a second pressing device (17) is provided in an effective connection with the clutch actuator (7).

This application is a national stage completion of PCT/EP2006/003508 filed Apr. 18, 2006 which claims priority from German Application Serial No. 10 2005 021 416.9 filed May 10, 2005.

### FIELD OF THE INVENTION

The invention involves a power train of a motor vehicle with a drive motor constructed as a combustion engine, a transmission with variable transmission ratios connected to an axle drive, and with an automatic motor clutch, which is constructed as a friction clutch passively lockable by way of a spring-loaded pressing device and whose torque transfer (coupling moment) is adjusted using a clutch actuator, located in the power flow between the drive motor and the transmission.

The invention also involves a procedure to control an automatic motor clutch placed in the power train of a motor vehicle in the power flow between a drive motor constructed as a combustion engine and a transmission with variable transmission ratios connected to an axle drive, with the clutch constructed as a friction clutch passively lockable by a spring-loaded pressing device and whose torque transfer (coupling moment) is adjusted using a clutch actuator.

### BACKGROUND OF THE INVENTION

Motor clutches are known as passively or actively lockable friction clutches. A passively lockable friction clutch is locked in a non-activated state, i.e. when no external positioning force is either applied by the driver or produced with an actuator, by way of a self-activated, usually spring-loaded, pressing device and is at least partially unlocked in the activated operating condition by the impact of a disengaging device in an effective connection with the pressing device using an adjustable positioning force. An actively lockable friction clutch is completely unlocked in the inactivated state, i.e. when no external positioning force is applied, and is at least partially locked in the activated operating condition by the impact of an associated pressing device by way of an adjustable positioning force.

A passively lockable motor clutch automatically controlled by a hydraulic actuator is described, for example, in DE 43 09 901 A1. The motor clutch in question is constructed in a known manner as a single disc dry clutch whose pressing device includes a membrane spring placed between a clutch cover secured to the flywheel of the drive motor and the pressure plate on the transmission side. The associated hydraulic actuator is formed by a hydraulic slave cylinder which is connected via a hydraulic line with a hydraulic master cylinder. The master cylinder is a component part of a centering actuator of a hydraulic control which is controlled by a magnetic proportional valve or two synchronized magnetic relay valves.

The control of the degree of opening and thus the transferred torque of the motor clutch occurs via a directional sensor placed on the centering actuator. It thus primarily involves a relatively complex directional control of an automatic friction clutch.

The advantage of this type of clutch construction is that in the event of a motor clutch failure, which is usually associated with a loss of pressure in the hydraulic control, the motor clutch remains locked or independently moves to the locked position. Thus, the driver can drive the vehicle at least to a safe parking place or to a service workshop.

The disadvantage of this type of clutch construction, however, is the high complexity of component parts, in particular for the pressing device and the disengaging device, as well as the high, technical complexity of the clutch control which is especially required due to the non-proportional spring characteristic of the membrane spring. In addition, there is also the fact, that to adjust a certain coupling torque, starting from the condition of rest, the actuator first must bridge an empty run and then remove the excess pressure, which results in a definite delay and a poor response of the clutch control.

On the other hand, an actively lockable clutch automatically controlled by a hydraulic actuator is known from DE 102 40 679 B4 which can be used as a motor clutch in addition to a use as a power shift clutch or power shift brake in an automatic planetary gear transmission. The clutch is constructed in a known manner as a multi-disc in oil batch clutch (wet clutch) whose pressing device is constructed from a hydraulic centering actuator, the piston of which can be brought in contact on one side with the first disc of the disc packet and whose pressure area is enclosed between the housing and the piston.

By means of a special spring arrangement one can provide, on the one hand, that the piston in the inactivated condition of rest is pressed by a spring-supported reset force into a position at a distance from the first disc, so that all discs are unstressed and the multiple disc clutch is completely opened. On the other hand, due to the spring arrangement during the activation of the piston a strong incipient increase of the spring-supported, reset force is caused, i.e., the start of the torque transfer, upon reaching the first disc whereby a good adjustability of the set coupling torque level is possible, in particular also a simple, low-priced, pressure-controlled regulation of the transferred torque of the motor clutch.

A serious disadvantage of this type of clutch construction is the fact that the motor clutch is automatically opened in the event of a malfunction caused by leakage associated with a loss of pressure in the hydraulic control. As a result the driver cannot drive the affected vehicle at least to a safe parking place or to a service garage, but instead the vehicle remains at a location not selected by the driver and also possibly dangerous and has to be towed.

A further disadvantage of this type of construction is the fact that to adjust a certain coupling torque when starting from an inactivated condition of rest an empty run must first be bridged by the actuator which can result in a certain delay in the response behavior of the clutch control.

Against this background the purpose of the present invention is to propose an automatic motor clutch for a power train of the above specified type which features a simple and low cost construction resulting in improved controllability and improved response behavior. In addition, a procedure to control such a motor clutch is to be provided.

The solution of the task regarding the motor clutch consists of a spring-supported, pressing device being designed for the production of a basic coupling torque below the maximum torque of the drive motor and a second pressing device connected to the clutch actuator being provided for the production of a higher coupling torque.

### SUMMARY OF THE INVENTION

The motor clutch of the invention, which can be constructed as both a dry clutch and a wet clutch, involves a passively lockable friction clutch which in the inactivated operating condition, i.e., with no power in the clutch actuator, automatically locks or is held locked by means of the spring-supported pressing device. The spring-supported pressing device of the invention, however, in contrast to the known motor clutches which are designed for a basic coupling torque of about 200% of the maximum torque of the drive motor (excess pressure), is designed for a basic coupling torque being well below the maximum torque of the drive motor, which can, for example, correspond to the drag moment or the idling moment of the drive motor. An increase of the coupling torque then occurs in the invention by means of a second pressing device, whereby the coupling torque established in this manner is largely proportional to the positioning force produced by the associated clutch actuator.

All in all, compared to the known clutch constructions, this results in improved controllability, enables a simple and low cost control device to control the clutch actuator and an inexpensive and space-saving mounting of the motor clutch. Thus the spring-supported pressing device and the clutch components stressed by it can be constructed relatively simply and economically because of the lower stress.

Since the basic regulation of the motor clutch occurs automatically via the spring-supported pressing device, the second pressing device can be constructed largely free of play which means a faster response behavior of the clutch control. Thus the starting and shifting procedures can be performed more dynamically and the shifting times for the shifting procedures can be shortened for a drive transmission constructed as a manual transmission.

Furthermore, the spring-supported, pressing device ensures that the motor clutch remains locked in the event of a malfunction in the clutch actuator or the associated clutch control, even with a relatively small transferable torque. Thus in the event of a malfunction the vehicle in question can be driven at a reduced speed to a safe parking place or a service workshop.

To reduce the coupling torque below a basic coupling torque and/or for a complete opening of the motor clutch, it is useful to include a disengaging device activated by means of a controllable actuator whose activation is advantageously linked with that of the second pressing device in a common clutch actuator.

The clutch actuator of the second pressing device and/or the disengagement device can in principle be pressure-activated, i.e., constructed to have a pneumatic or hydraulic action or an electromagnetic action or that of an electric motor. Thus the clutch actuator can be constructed as a pressure-activated centering actuator which is attached to a pressure source via a connection line and a clutch control device.

For example, the clutch actuator with a pneumatic construction can be usefully connected to a pressure supply device of a vehicle. It is also possible that the clutch actuator with a hydraulic construction can be attached to an available hydraulic pressure supply device of a motor vehicle, e.g., a hydraulic switching or translation control of the drive transmission.

In a construction involving an electromagnetic action or that of an electric motor the clutch actuator of the second pressing device and/or the disengagement device can be usefully connected to the vehicle's electric onboard network via an electronic power control. The support of the positioning force of the clutch actuator preferably occurs within the motor clutch but can also occur by means of an appropriate formation and arrangement of the motor clutch and the clutch actuator opposite the motor housing of the drive housing or opposite the transmission housing of the drive transmission.

If the design of the clutch actuator involves a pressure activation that preferably includes a double-acting centering actuator, an axially movable setting piston placed inside the centering actuator and two pressure areas on both sides of the setting pistons enclosed by the centering actuator and the setting piston, whereby the first pressure area borders the setting piston on the transmission side and is connected to a pressure source via an initial connecting line across a clutch control device, whereby the second pressure area borders the setting piston on the clutch side and is connected to a pressure source via a second connecting line across a clutch control device, and whereby the centering actuator or the setting piston is connected with a support element of the motor clutch and the other component (setting piston or centering actuator) with a pressing element of the motor clutch.

When the motor clutch is constructed as a single or multi-plate dry clutch with a clutch cover secured to the flywheel of the drive motor and a pressure plate on the transmission side, the centering actuator is advantageously constructed by means of a ring-shaped molding in the clutch cover and an appropriate ring-shaped setting piston that is connected to the pressure plate, thereby resulting in a simple, low cost design of the motor clutch that requires little construction space.

To control the common clutch actuator, the clutch control device regulated by an electronic control device can, for example, be a combination of two 2/2 distributing valves, one reversing valve, and a pressure sensor. Using the first 2/2 distributing valve the pressure area connection to the source of the pressure medium can be opened or closed. The second 2/2 distributing valve serves to open or close a pressure area connection to a source of a pressure medium or a non-pressurized line. The reversing valve mentioned above is placed between the two 2/2 distributing valves and the two pressure areas using pressure technology, so that by means of it a connection between the two pressure areas can be opened or closed.

It is therefore possible using this combination of valves to fill or empty one of the two pressure areas by means of the two 2/2 distributing valves, as well as to hold the other pressure area at the pressure previously produced by the control.

With the help of the mentioned pressure sensor which preferably is positioned in a connecting line between the two 2/2 distributing valves and the reversing valve, the pressure in the freely selected pressure areas can be determined and adjusted. As a result, it is possible to regulate the maximum clutch transmission torque or a portion of it, in that one pressure chamber is de-aerated or the other pressure chamber aerated. The clutch transmission torque between this maximum torque and the basic coupling torque, produced by the spring-supported pressing device, is thereby proportional to the pressure in the aerated pressure chamber. By de-aerating this pressure chamber and aerating the other pressure chamber, it is possible to regulate a coupling torque below the basic coupling torque or to completely open the clutch. Moreover it is possible by using of other pressure regulating devices, like for example, proportional valves or other valve combinations, to produce comparable coupling behaviors.

In another variant of the clutch control device it can be provided, that it includes two pressure regulating valves which are connected at the input side with the connection line leading to the source of the pressure medium and from there the first pressure regulating valve is connected on the output side with a connection line leading to the first pressure area and the second pressure regulating valve on the output side with the connection line to the second pressure area. By means of the first pressure regulating valve, the pressure in the first pressure area and thus the clutch transmission torque between the basic coupling torque and the maximum coupling torque is regulated. Using the second pressure regulating valve, the pressure in the second pressure area and thus the coupling torque between the basic coupling torque and the complete opening of the clutch is regulated.

Another variant of the clutch control mechanism includes four 2/2 distributing valves as well as two pressure sensors, whereby the first pair of 2/2 distributing valves is connected with the connection line leading to the source of the pressure medium and the other two 2/2 distributing valves are connected to a non-pressurized line. It is also provided that the first two 2/2 distributing valves are connected with the connection line leading to the second pressure area as well as the two other 2/2 distributing valves are connected to the connection line to the first pressure area.

The two pressure sensors are thereby so positioned, that they can measure the pressure in the connection line between the first two 2/2 distributing valves and the second pressure area or the connection line between the second two 2/2 distributing valves and the first pressure area.

Using this type of construction of the clutch control device the pressure in the second pressure area can be determined by a reasonable activation of a first group of two 2/2 distributing valves of these four 2/2 distributing valves with the help of a first pressure sensor and thus the clutch transmission torque between the basic coupling torque and the complete opening of the clutch is regulated. By a reasonable activation of the second group of two 2/2 distributing valves the pressure in the first pressure area can be determined by the other pressure sensor and on the basis of it the clutch transmission torque between the basic coupling torque and the maximum coupling torque can then be regulated.

Finally according to the invention it can be provided that the basic coupling torque produced by the spring-supported pressing device corresponds to the drag torque of the drive motor or to the idle torque of the drive motor.

The solution of the task with respect to a control procedure results in such a way that by means of the spring-supported pressing device a basic coupling torque lying below the maximum torque of the drive motor is automatically produced and that a higher coupling torque is regulated by means of an additional second pressing device in an effective connection with the clutch actuator.

A decrease of the coupling torque below the basic coupling torque and/or a complete opening of the motor clutch occurs by means of a disengagement device activated by a controllable actuator, whereby this actuator is combined with that of the second pressing device into a common clutch actuator.

### BRIEF DESCRIPTION OF THE DRAWINGS

For an explanation of the invention, drawings of various embodiments are attached to the description. Schematically depicted in:

FIG. 1 is a power train with a motor clutch according to the invention and an associated clutch control device;

FIG. 2 is a first variant of a clutch control device for the power train according to FIG. 1;

FIG. 3 is a second variant of a clutch control device; and

FIG. 4 is a third variant.

### DETAILED DESCRIPTION OF THE INVENTION

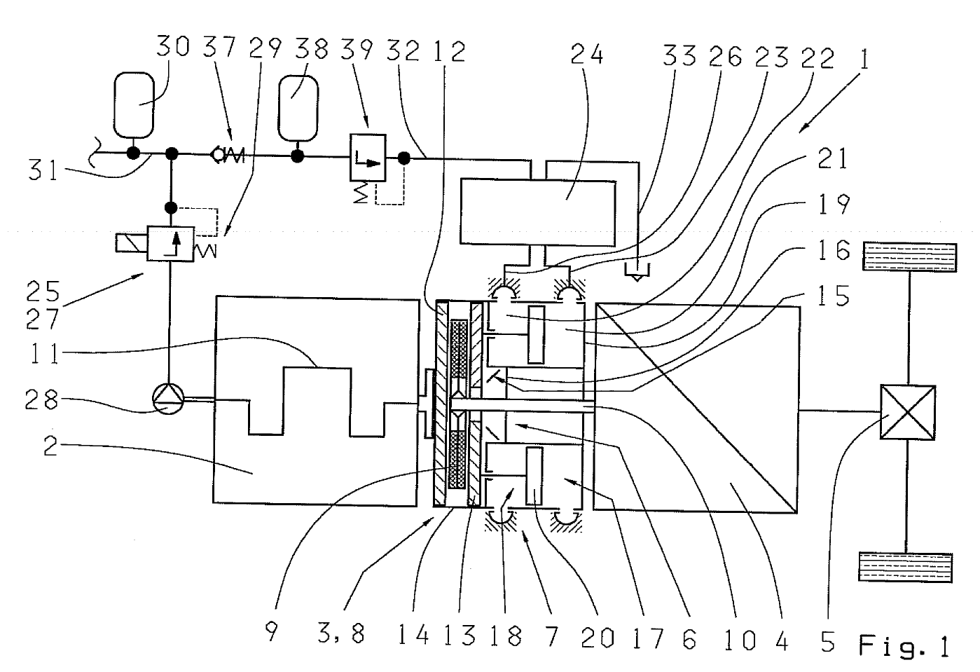

According to FIG. 1 a power train 1 of a motor vehicle includes a drive motor 2 constructed as a combustion engine, a transmission 4 with variable, i.e. shiftable in stages or continuously varying, transmission ratios connected to an axle drive 5, and with an automatic motor clutch 3, constructed as a passively lockable friction clutch by means of a spring-loaded pressing device 6 and whose transferable torque (coupling torque) is adjusted using a clutch actuator 7, located in the power flow between the drive motor 2 and the transmission 4.

The motor clutch 3 is constructed primarily a single-plate dry clutch B. Thus a supported, axially shiftable clutch plate 9 is placed in a known manner on the input shaft 10 of the transmission 4, between a flywheel 12 that is rigidly connected with a crankshaft 11 of the drive motor and a pressure plate 13 on the transmission side. The pressure plate 13 rotationally fixed but axially shiftable in a clutch cover 14 which is rigidly connected with the flywheel 12. The spring-supported pressing device 6 is primarily constructed as a pressing spring 15 designed as a spring washer which is effectively placed between the pressure plate 13 and a ring base 16 of the clutch cover 14. The pressure plate 13 is pressed by the spring force of the pressing spring 15 in the direction toward the drive motor and thus the clutch plate 9 is clamped between the flywheel 12 and the pressure plate 13, whereby a torque can be transferred in a frictionally locked manner from the crankshaft 11 of the drive motor 12 to the input shaft 10 of the transmission 4.

In any event, the spring-supported pressing device 6 or as the case may be the pressing spring 15 is primarily designed in the invention for the production of a basic coupling torque lying below the maximum rotational torque of the drive motor 2. The clutch actuator 7, which primarily is constructed to act pneumatically, serves to increase the transferable torque and to open the motor clutch 3 and in which an additional second pressing device 17 and a disengaging device 18 are combined.

For that reason the clutch cover 15 features on the side facing the transmission, by means of a ring-shaped molding, a double acting centering actuator 19 in which a likewise ring-shaped setting piston 20 is connected to the pressure plate 13, is positioned to axially displace.

The centering actuator 19 and the setting piston 20 enclose a ring-shaped pressure area 21, 22 on both sides of the setting piston 20, an initial pressure area 21 on the transmission side, which is connected via a first connection line 23 and a clutch control device 24 with a source of the pressure medium 25 and with the clutch actuator 7, forms the second pressing device 17, and on the motor side a second pressure area 22, which is connected via a second connection line 26, and the clutch control unit 24 with the source of the pressure medium 25 and with the clutch actuator 7, forms the disengagement device 18.

By the buildup of the effective pressure in the first pressure area 21, the pressure plate 13 acting as the pressing element is pushed by the setting piston 20 in the direction to the drive motor 2 and thus an increased coupling torque is produced in the effective direction of the pressing spring 15. By way of the buildup of an effective pressure in the second pressure area 22 the pressure plate 13 is pushed by the setting piston 20 in the direction of the transmission 4 and thus a diminished coupling torque is regulated against the effective direction of the pressing spring 15 or the motor clutch 3 is completely opened, if applicable.

A pressurized air supply device 27 of the vehicle serves as the source of the pressure medium 25. It comprises a compressor 28 powered by the drive motor, a controllable pressure limiting valve 29 by means of which air pressure is delivered into a system pressure line 31 provided with a pressure reservoir 30. Consumers that are not illustrated can be connected to the system pressure line 31.

The clutch control device 24 is depicted only symbolically in FIG. 1. It preferably includes electromagnetically activated relay valves which are controlled by an electronic control device that is not illustrated, based on sensor information and control or regulation commands for clutch activation.

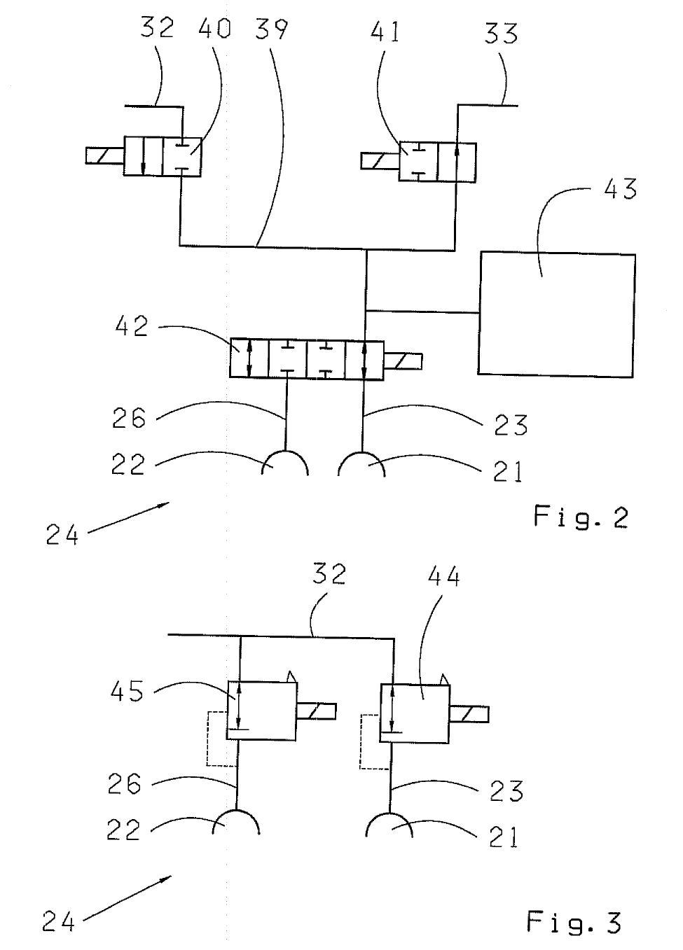

As shown in FIG. 2 the clutch control device 24 can include two 2/2 distributing valves 40 and 41 as well as a pressure sensor 43 and a reversing valve 42 which are connected to each other as shown via connection lines. The first 2/2 distributing valve 40 is thereby equipped with a connection for a connection line 32 which leads to the source 25 of the pressure medium and with a connection for a connection line 39 leading to a reversing valve 42. The second 2/2 distributing valve 41 is equipped with a connection for a connecting line 30 to a reversing valve 42 and a connection to the non-pressurized line 33. The reversing valve 42 has a connection with which it can be attached to connection line to the two 2/2 distributing valves 40, 41. In addition, the reversing valve 42 is connected to both connecting lines 23 and 26 which lead to the first pressure area 21 and the second pressure area 22.

Finally, FIG. 2 shows that the pressure sensor 43 is positioned so it can measure the pressure in the connection line 39 between the two 2/2 distributing valves 40, 41 and the reversing valve 42. Its measurements show the pressure in pressure area 21 or 22 with which this pressure sensor 43 is connected at the same pressure level by means of the indexing position of the reversing valve 42. The pressure sensor 43 is connected using signal technology to the electronic control device that is not shown here and which performs the control of the clutch control device 24 or its control valves 40, 41, 42 based on the measured values of the pressure sensor 43.

FIG. 3 shows another variant of the clutch control device 24 which basically includes two pressure regulating valves 44, 45. Both these pressure regulating valves 44 and 45 are connected, on an input side, with the connection line 32 leading to the source of the pressure medium 25. In addition, the first pressure regulating valve 44 is connected, on an output side, with the connection line 23 leading to the first pressure area 21 and the second pressure regulating valve 45 is connected on the output side with the connecting line 26 leading to the second pressure area 22. With this type of clutch control device 24 the pressure limiting valve 39 can be omitted as seen in FIG. 1, thus lowering the cost.

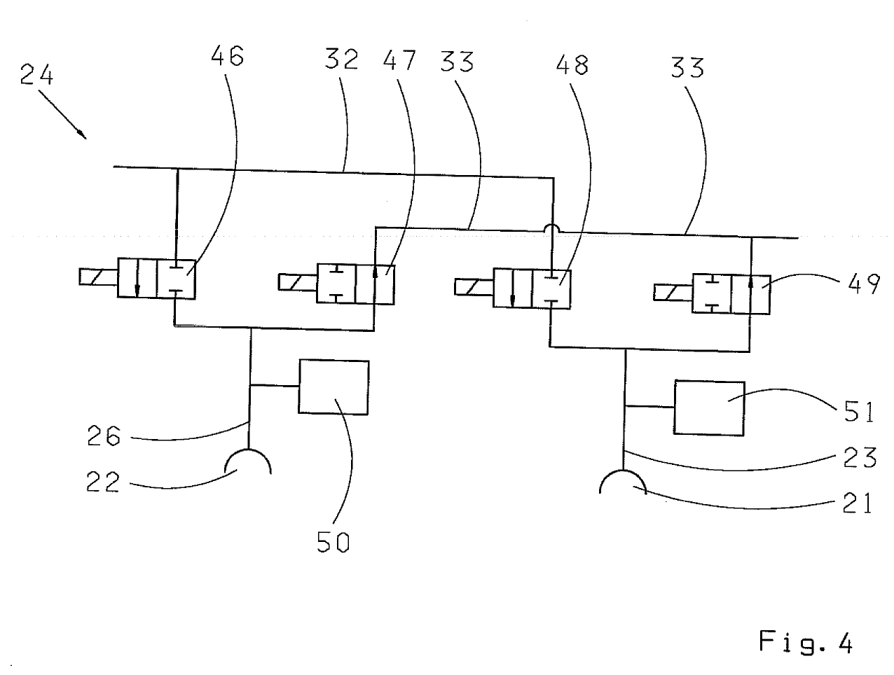

According to another variant of the clutch control device 24 shown in FIG. 4, it basically includes four 2/2 distributing valves 46, 47, 48, 49 as well as two pressure sensors 50, 51, whereby each two 2/2 distributing valves 46, 48 are connected on the input side with the connection line 32 leading to the source of pressure medium 25 and the two other 2/2 distributing valves 47 and 49 are connected on the output side with the non-pressurized line 33. In addition, it is also provided, that two 2/2 distributing valves 46 and 47 are connected to the connecting line 26 leading to the second pressure area 22 as well as the two 2/2 distributing valves 48 and 49 are connected with the connection line 23 leading to the first pressure area 21.

The second pressure area 22 can be aerated or de-aerated using this clutch control device 24 by activation of a first group of two 2/2 distributing valves 46, 47 and by means of the second pressure sensor 50, the pressure in the second pressure area 22 can be determined as well as the associated coupling torque can be regulated between the basic coupling torque and the complete opening of the clutch 3. By means of an expedient activation of the second group of two 2/2 distributing valves 48, 49, the first pressure area 21 can be aerated or de-aerated and by using the first pressure sensor 51 the pressure in the first pressure area 21 can be determined and on its basis the coupling transmission torque between the basic coupling torque and the maximum coupling torque can be regulated.

By adjusting the interim positions on the clutch control device 24 the effective pressure in both pressure areas 21, 22 and thus the transferred torque of the motor clutch 3 can be continuously adjusted.

To maintain the clutch control with a loss of pressure in the source of the pressure medium 25, a return stroke valve 37 with a blockage effect in the direction of the source of the pressure medium and a separate pressure reservoir 38 are placed in connection line 32. In addition, connection line 32 to limit the system pressure of the clutch control is provided with a pressure limiting valve 39.

Because of a relatively low stress on the component parts, a construction largely free of play and a possible pressure control, the motor clutch 3 of the invention manifests an improved controllability and a faster response behavior with a simple and low cost construction.

### REFERENCE SIGNS

1 Power train
2 Drive motor
3 Motor clutch
4 Transmission
5 Axle drive
6 Spring-supported pressing device
7 Clutch actuator
8 Single-plate dry clutch
9 Clutch plate
10 Input shaft
11 Crankshaft
12 Flywheel
13 Pressure plate, pressing element
14 Clutch cover, support element
15 Pressing spring
16 Ring carrier
17 Second pressing device
18 Disengaging device
19 Centering actuator
20 Setting piston
21 First pressure area
22 Second pressure area
23 First connection line
24 Clutch control device
25 Source of pressure medium
26 Second connection line
27 Pressurized air supply device
28 Compressor
29 Pressure limiting valve
30 Pressure reservoir
31 System pressure line
32 Connection line
33 Non-pressurized line
37 Return stroke valve
38 Pressure reservoir
39 Pressure limiting valve
40 2/2 Distributing valve
41 2/2 Distributing valve
42 Reversing valve
43 Pressure sensor
44 First pressure regulating valve
45 Second pressure regulating valve
46 2/2 Distributing valve
47 2/2 Distributing valve
48 2/2 Distributing valve
49 2/2 Distributing valve
50 Pressure sensor
51 Pressure sensor

1-19. (canceled)

20. A power train of a vehicle having a drive motor (2), a transmission (4) with variable transmission ratios connected to an axle drive (5), and with an automatic motor clutch (3) which is a passively engagable friction clutch, engaged by a spring-supported pressing device (6), a coupling torque of the motor clutch (3) is adjusted using a clutch actuator (7), which is located in a flow power between the drive motor (2) and the transmission (4), the spring-supported pressing device (6) generates a basic coupling torque, lower than a maximum torque of the drive motor (2), a second pressing device (17), which is in an effective connection with the clutch actuator (7), regulates a higher coupling torque, a disengaging device (18), which is activated by a controllable actuator, to at least one of lower the coupling torque below the basic coupling torque and completely disengage the motor clutch (3), the second pressing device (17) and the disengaging device (18) are activated jointly by the clutch actuator (7), the clutch actuator (7) of the second pressing device (17) and the disengaging device (18) includes a double-acting centering actuator (19), a setting piston (20) axially movable in the centering actuator (19), and first and second pressure areas (21, 22), located on opposite sides of the setting piston (20), are enclosed by the centering actuator (19) and the setting piston (20), the first pressure area (21) borders the setting piston (20) on a transmission side and is connected, via a first connection line (23), across a clutch control device (24), with a source of the pressure medium (25), the second pressure area (22) borders the setting piston (20) on a clutch side and is connected, via a second connection line (26), across the clutch control device (24), with the source of the pressure medium (25), and one of the centering actuator (19) and the setting piston (20) is connected with a support element (14) of the motor clutch (3) and the other of the setting piston (20) and the centering actuator (19) is connected with a pressing element (13) of the motor clutch (3), the clutch control device (24) controls the clutch actuator (7) with which, in an inactivated operating condition, a connection of the first and the second connection lines (23, 26) with the source of the pressure medium (25) is completely closed and a connection of the first and the second connection lines (23, 26) with a non-pressurized line (33) is completely opened, in the activated condition a connection of the first connection line (23) with the source of the pressure medium (25) is at least partially opened to increase the coupling torque, the connection of the first connection line (23) with the non-pressurized line (33) is at least partially closed, the connection of the second connection line (26) with the source of the pressure medium (25) is at least partially closed, and the connection of the second connection line (26) with the non-pressurized line (33) is at least partially opened, and in the activated operating condition the connection of the first connection line (23) with the source of the pressure medium (25) is at least partially closed to reduce the coupling torque, the connection of the first connection line (23) with the non-pressurized line (33) is at least partially opened, the connection of the second connection line (26) with the source of the pressure medium (25) is at least partially opened, and the connection of the second connection line (26) with the non-pressurized line (33) is at least partially closed, the clutch control device (24) includes first and second 2/2 distributing valves (40, 41), a reversing valve (42) and a pressure sensor (43), the first initial 2/2 distributing valve (40) is connected by a first connection line (32) to the source of the pressure medium (25), and by a second connection line (39) to the reversing valve (42), the second 2/2 distributing valve (41) is connected, by the second connection line (39), to the reversing valve (42) and to the non-pressurized line (33), the reversing valve (42) is connected by the third connection line (39) to the first and the second 2/2 distributing valves (40, 41), by the non-pressurized line (23) to the first pressure area (21) and by the second connection line (26) to the second pressure area (22).

21. The power train according to claim 20, wherein the pressure sensor (43) measures a pressure in the second connection line (39) between the first and the second 2/2 distributing valves (40, 41) and the reversing valve (42) and the pressure sensor (43) is connected with an electronic control device to control the clutch control device (24; 40, 41, 42, 43) based on the pressure measured by the pressure sensor (43).

22. A power train of a vehicle having a drive motor (2), a transmission (4) with variable transmission ratios connected to an axle drive (5), and with an automatic motor clutch (3) which is a passively engagable friction clutch, engaged by a spring-supported pressing device (6), a coupling torque of the motor clutch (3) is adjusted using a clutch actuator (7), which is located in a flow power between the drive motor (2) and the transmission (4), the spring-supported pressing device (6) generates a basic coupling torque, lower than a maximum torque of the drive motor (2), a second pressing device (17), which is in an effective connection with the clutch actuator (7), regulates a higher coupling torque, a disengaging device (18), which is activated by a controllable actuator, to at least one of lower the coupling torque below the basic coupling torque and completely disengage the motor clutch (3), the second pressing device (17) and the disengaging device (18) are activated jointly by the clutch actuator (7), the clutch actuator (7) of the second pressing device (17) and the disengaging device (18) includes a double-acting centering actuator (19), a setting piston (20) axially movable in the centering actuator (19), and first and second pressure areas (21, 22), located on opposite sides of the setting piston (20), are enclosed by the centering actuator (19) and the setting piston (20), the first pressure area (21) borders the setting piston (20) on a transmission side and is connected, via a first connection line (23), across a clutch control device (24), with a source of the pressure medium (25), the second pressure area (22) borders the setting piston (20) on a clutch side and is connected, via a second connection line (26), across the clutch control device (24), with the source of the pressure medium (25), and one of the centering actuator (19) and the setting piston (20) is connected with a support element (14) of the motor clutch (3) and the other of the setting piston (20) and the centering actuator (19) is connected with a pressing element (13) of the motor clutch (3), the clutch control device (24) controls the clutch actuator (7) with which, in an inactivated operating condition, a connection of the first and the second connection lines (23, 26) with the source of the pressure medium (25) is completely closed and a connection of the first and the second connection lines (23, 26) with a non-pressurized line (33) is completely opened, in the activated condition a connection of the first connection line (23) with the source of the pressure medium (25) is at least partially opened to increase the coupling torque, the connection of the first connection line (23) with the non-pressurized line (33) is at least partially closed, the connection of the second connection line (26) with the source of the pressure medium (25) is at least partially closed, and the connection of the second connection line (26) with the non-pressurized line (33) is at least partially opened, and in the activated operating condition the connection of the first connection line (23) with the source of the pressure medium (25) is at least partially closed to reduce the coupling torque, the connection of the first connection line (23) with the non-pressurized line (33) is at least partially opened, the connection of the second connection line (26) with the source of the pressure medium (25) is at least partially opened, and the connection of the second connection line (26) with the non-pressurized line (33) is at least partially closed, the clutch control device (24) includes first and second pressure regulating valves (44, 45) which are both connected, on an input side via a connection line (32), to the source of the pressure medium (25), the first pressure regulating valve (44) is connected on an output side, via the first connection line (23), to the first pressure area (21) and the second pressure regulating valve (45) is connected on an output side, via the second connection line (26), to the second pressure area (22).

23. A power train of a vehicle having a drive motor (2), a transmission (4) with variable transmission ratios connected to an axle drive (5), and with an automatic motor clutch (3) which is a passively engagable friction clutch, engaged by a spring-supported pressing device (6), a coupling torque of the motor clutch (3) is adjusted using a clutch actuator (7), which is located in a flow power between the drive motor (2) and the transmission (4), the spring-supported pressing device (6) generates a basic coupling torque, lower than a maximum torque of the drive motor (2), a second pressing device (17), which is in an effective connection with the clutch actuator (7), regulates a higher coupling torque, a disengaging device (18), which is activated by a controllable actuator, to at least one of lower the coupling torque below the basic coupling torque and completely disengage the motor clutch (3), the second pressing device (17) and the disengaging device (18) are activated jointly by the clutch actuator (7), the clutch actuator (7) of the second pressing device (17) and the disengaging device (18) includes a double-acting centering actuator (19), a setting piston (20) axially movable in the centering actuator (19), and first and second pressure areas (21, 22), located on opposite sides of the setting piston (20), are enclosed by the centering actuator (19) and the setting piston (20), the first pressure area (21) borders the setting piston (20) on a transmission side and is connected, via a first connection line (23), across a clutch control device (24), with a source of the pressure medium (25), the second pressure area (22) borders the setting piston (20) on a clutch side and is connected, via a second connection line (26), across the clutch control device (24), with the source of the pressure medium (25), and one of the centering actuator (19) and the setting piston (20) is connected with a support element (14) of the motor clutch (3) and the other of the setting piston (20) and the centering actuator (19) is connected with a pressing element (13) of the motor clutch (3), the clutch control device (24) controls the clutch actuator (7) with which, in an inactivated operating condition, a connection of the first and the second connection lines (23, 26) with the source of the pressure medium (25) is completely closed and a connection of the first and the second connection lines (23, 26) with a non-pressurized line (33) is completely opened, in the activated condition a connection of the first connection line (23) with the source of the pressure medium (25) is at least partially opened to increase the coupling torque, the connection of the first connection line (23) with the non-pressurized line (33) is at least partially closed, the connection of the second connection line (26) with the source of the pressure medium (25) is at least partially closed, and the connection of the second connection line (26) with the non-pressurized line (33) is at least partially opened, and in the activated operating condition the connection of the first connection line (23) with the source of the pressure medium (25) is at least partially closed to reduce the coupling torque, the connection of the first connection line (23) with the non-pressurized line (33) is at least partially opened, the connection of the second connection line (26) with the source of the pressure medium (25) is at least partially opened, and the connection of the second connection line (26) with the non-pressurized line (33) is at least partially closed, the clutch control (24) includes first, second, third and fourth 2/2 distributing valves (46, 47, 48, 49), and first and second pressure sensors (50, 51), the first and the third 2/2 distributing valves (46, 48) are connected on an input side, via a connection line (32), to the source of the pressure medium (25), the second and the fourth 2/2 distributing valves (47, 49) are connected on an output side with the non-pressurized line (33) and, via the second connection line (26), to the second pressure area (22), and the third and the fourth 2/2 distributing valves (48, 49) are connected, via the first connection line (23), to the first pressure area (21).

24. The power train according to claim 23, wherein the first pressure sensor (50) measures a pressure in the second connection line (26) between the first 2/2 distributing valve (46) and the second pressure sensor (51) measures a pressure in the connection line (23) between the third and the fourth 2/2 distributing valves (48, 49) and the first pressure area (21).

25. The power train according to claim 20, wherein the clutch actuator (7) is pneumatic and is attached to a pressurized air supply unit (27) of the vehicle.

26. The power train according to claim 20, wherein the clutch actuator (7) is hydraulic and is attached to a hydraulic pressure supply unit of the vehicle.

27. The power train according to claim 20, wherein the basic coupling torque produced by the spring-supported pressing device (6) corresponds to a drag torque of the drive motor (2).

28. The power train according to claim 20, wherein the basic coupling torque produced by the spring-supported pressing device (6) corresponds to an idling torque of the drive motor (2).
